(19) United States
(12) Patent Application Publication
(10) Pub. No.: US 2026/0154117 A1
(43) Pub. Date: Jun. 4, 2026

(54) MULTIMEDIA DATA PROCESSING METHOD, ELECTRONIC DEVICE, SERVER, AND STORAGE MEDIUM

(71) Applicant: Beijing Zitiao Network Technology Co., Ltd., Beijing (CN)

(72) Inventors: Pude ZHOU, Beijing (CN); Yu Yang, Beijing (CN); Qiang Yu, Beijing (CN)

(21) Appl. No.: 19/402,597

(22) Filed: Nov. 26, 2025

(30) Foreign Application Priority Data
Nov. 29, 2024 (CN) 202411751315.X

(51) Int. Cl. G06F 9/50

(52) U.S. Cl. CPC G06F 9/5027

(57) ABSTRACT

A multimedia data processing method, an electronic device, a s server, and a storage medium are provided. The multimedia data processing method includes: transmitting a first launch request of a cloud application, where the first launch request is a request for triggering to launch the cloud application; obtaining multimedia data of at least two application instances, where the at least two application instances are launched for the cloud application on different cloud containers, different cloud containers correspond to different running environments of the cloud application, and the application instances at least include a first instance and a second instance; displaying multimedia data of the first instance; and switching displayed content from the multimedia data of the first instance to multimedia data of the second instance when the first instance is abnormal.

### CROSS-REFERENCE TO RELATED APPLICATION(S)

The present application claims priority to Chinese Patent Application No. 202411751315.X, filed on Nov. 29, 2024, which is incorporated herein by reference in its entirety as a part of the present application.

### TECHNICAL FIELD

An embodiment of the present disclosure relates to computer technologies.

### BACKGROUND

Cloud application is an application running in the cloud based on a cloud computing technology. The cloud application may be affected by the performance of a cloud container or the vulnerabilities of the cloud application itself in the running process, which may cause the cloud application to be abnormal.

When the cloud application encounters anomaly, relaunching becomes the sole recovery method to restore normal operation. However, this single recovery approach exhibits significant limitations. Frequent relaunching may affect continuity and stability of the cloud application, and may cause business disruption and other adverse effects for some business scenarios with high real-time requirements.

### SUMMARY

An embodiment of the present disclosure provides a multimedia data processing method, including:
transmitting a first launch request of a cloud application, where the first launch request is a request for triggering to launch the cloud application;
obtaining multimedia data of at least two application instances, where the at least two application instances are instances launched for the cloud application on different cloud containers, the different cloud containers correspond to different running environments of the cloud application, and the application instances at least include a first instance and a second instance;
displaying multimedia data of the first instance; and
switching displayed content from the multimedia data of the first instance to multimedia data of the second instance when the first instance is abnormal.

An embodiment of the present disclosure provides a multimedia data processing method, including:
obtaining a first launch request of a cloud application transmitted by an electronic device, where the first launch request is a request for triggering to launch the cloud application;
launching application instances for the cloud application on at least two cloud containers in response to the first launch request, where the application instances at least include a first instance and a second instance; and
transmitting multimedia data of the at least two application instances to the electronic device.

An embodiment of the present disclosure further provides a multimedia data processing apparatus, including:
a transmission module, configured to transmit a first launch request of a cloud application, where the first launch request is a request for triggering to launch the cloud application;
an obtaining module, configured to obtain multimedia data of at least two application instances, where the at least two application instances are instances launched for the cloud application on different cloud containers, the different cloud containers correspond to different running environments of the cloud application, and the application instances at least include a first instance and a second instance;
a display module, configured to display multimedia data of the first instance; and
a switching module, configured to switch displayed content from the multimedia data of the first instance to multimedia data of the second instance when the first instance is abnormal.

An embodiment of the present disclosure further provides a multimedia data processing apparatus, including:
an obtaining module, configured to obtain a first launch request of a cloud application transmitted by an electronic device, where the first launch request is a request for triggering to launch the cloud application;
a launching module, configured to launch application instances for the cloud application on at least two cloud containers in response to the first launch request, where the application instances at least include a first instance and a second instance; and
a transmission module, configured to transmit multimedia data of the at least two application instances to the electronic device.

An embodiment of the present disclosure further provides an electronic device, including:
one or more processing apparatuses; and a storage apparatus, configured to store one or more programs.

When the one or more programs are executed by the one or more processing apparatuses, the one or more processing apparatuses are enabled to implement the multimedia processing method provided by the embodiment of the present disclosure.

An embodiment of the present disclosure further provides a server, including:
one or more processing apparatuses; and
a storage apparatus, configured to store one or more programs.

When the one or more programs are executed by the one or more processing apparatuses, the one or more processing apparatuses are enabled to implement the multimedia processing method provided by the embodiment of the present disclosure.

An embodiment of the present disclosure further provides a storage medium including a computer-executable instruction, where the computer-executable instruction, when executed by a computer processor, is configured to execute the multimedia processing method provided by the embodiment of the present disclosure.

An embodiment of the present disclosure further provides a computer program product, including a computer program, where the computer program, when executed by a processor, is configured to implement the multimedia processing method provided by the embodiment of the present disclosure.

### BRIEF DESCRIPTION OF DRAWINGS

The foregoing and other features, advantages and aspects of various embodiments of the present disclosure will become more clearly in conjunction with the accompanying drawings and with reference to the following specific implementations. Throughout the accompanying drawings, the same or similar reference numerals indicate the same or similar elements. It should be understood that the accompanying drawings are schematic, and original and elements are not necessarily drawn to scale.

FIG. 1 is a flowchart of a multimedia data processing method according to an embodiment of the present disclosure;

FIG. 2 is a structural diagram of a system according to an embodiment of the present disclosure;

FIG. 3 is a flowchart of another multimedia data processing method according to an embodiment of the present disclosure;

FIG. 4 is a flowchart of still another multimedia data processing method according to an embodiment of the present disclosure;

FIG. 5 is a flowchart of yet another multimedia data processing method according to an embodiment of the present disclosure;

FIG. 6 is a diagram of system interaction according to an embodiment of the present disclosure;

FIG. 7 is a flowchart of synchronization according to an embodiment of the present disclosure;

FIG. 8 is a structural diagram of a multimedia data processing apparatus according to an embodiment of the present disclosure;

FIG. 9 is a structural diagram of another multimedia data processing apparatus according to an embodiment of the present disclosure;

FIG. 10 is a structural diagram of an electronic device according to an embodiment of the present disclosure;

FIG. 11 is a structural diagram of a server according to an embodiment of the present disclosure.

### DETAILED DESCRIPTION

Embodiments of the present disclosure are described in more detail below with reference to the accompanying drawings. Although some embodiments of the present disclosure are shown in the accompanying drawings, it should be understood that the present disclosure can be implemented in various forms and should not be construed as being limited to the embodiments set forth here, but rather, these embodiments are provided for a more thorough and complete understanding of the present disclosure. It should be understood that the accompanying drawings and embodiments of the present disclosure are used for illustration, and are not used to limit the scope of protection of the present disclosure.

It should be understood that various steps recorded in method implementations of the present disclosure can be executed according to different orders, and/or concurrently executed. In addition, the method implementations may include additional steps and/or omit performing the illustrated steps. The scope of the present disclosure is not limited in this aspect.

The term “comprising” and variations thereof as used herein are non-inclusive, that is, “including but not limited to”. The term “based on” means “based at least in part on”. The term “one embodiment” means “at least one embodiment”. The term “another embodiment” means “at least one another embodiment”. The term “some embodiments” means “at least some embodiments”. Related definitions of other terms will be given in the description below.

It should be noted that concepts such as “first” and “second” mentioned in the present disclosure are merely used to distinguish different apparatuses, modules or units, and are not used to limit the order or interdependence of functions executed by these apparatuses, modules or units.

It should be noted that the modification of “one” and “multiple” mentioned in the present disclosure is illustrative rather than restrictive, and those skilled in the art should understand that unless the context clearly indicates otherwise, they should be understood as “one or more”.

The names of messages or information exchanged between multiple apparatuses in the implementations of the present disclosure are only used for illustrative purposes, and are not used to limit the scope of these messages or information.

It may be understood that prior to using the technical solutions disclosed in various embodiments of the present disclosure, a user should be informed of type, usage scope, usage scenarios and the like of personal information involved in the present disclosure and authorization from the user should be acquired according to relevant laws and regulations in an appropriate manner.

For example, in response to receiving an active request of a user, prompt information is sent to the user to clearly remind the user that an operation to be executed as requested by the user will require obtaining and using personal information of the user. Thus, according to the prompt information, the user may autonomously choose whether to provide personal information to software or hardware such as an electronic device, an application, a server, or a storage medium that executes the operation of the technical solution of the present disclosure.

As an optional but non-restrictive implementation, in response to receiving an active request of a user, prompt information may be sent to the user through a pop-up window, where the prompt information may be presented in text. In addition, the pop-up window may also carry a selection control for the user to choose whether to “agree” or “disagree” to provide personal information to an electronic device.

It may be understood that the foregoing processes of informing and obtaining user authorization are only illustrative and do not constitute a limitation on the implementation of the present disclosure; and other modes that meet relevant laws and regulations may also be applied to the implementations of the present disclosure.

It may be understood that the data involved in the technical solution (including, but not limited to, the data itself, the acquisition or usage of data) should comply with requirements of corresponding laws, regulations and relevant stipulations.

At present, when the cloud application is abnormal, a relaunch button is provided on a human-computer interaction interface. Upon detecting problems, the user can click the relaunch button to relaunch the cloud application. The anomaly can be solved by relaunching the cloud application, making the stability of the cloud application reduced.

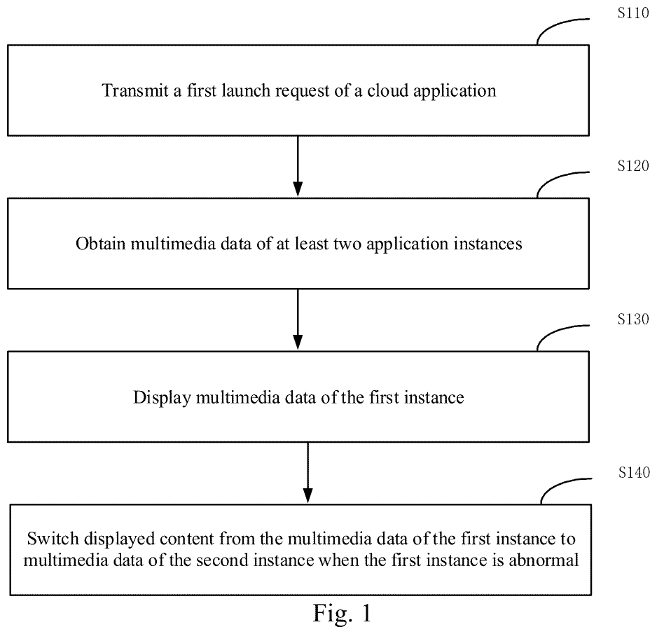

To solve the foregoing technical problem, the present disclosure provides a multimedia data processing method, and disaster recovery for a cloud application is enabled through a cloud container. FIG. 1 is a flowchart of a multimedia data processing method according to an embodiment of the present disclosure. The embodiment of the present disclosure is applicable to scenarios of running a cloud application on a terminal side and handling of anomaly of the cloud application. The method can be executed by a multimedia data processing apparatus, which can be implemented in the form of software and/or hardware, or alternatively by an electronic device, where the electronic device may be a mobile terminal, a PC terminal, and the like.

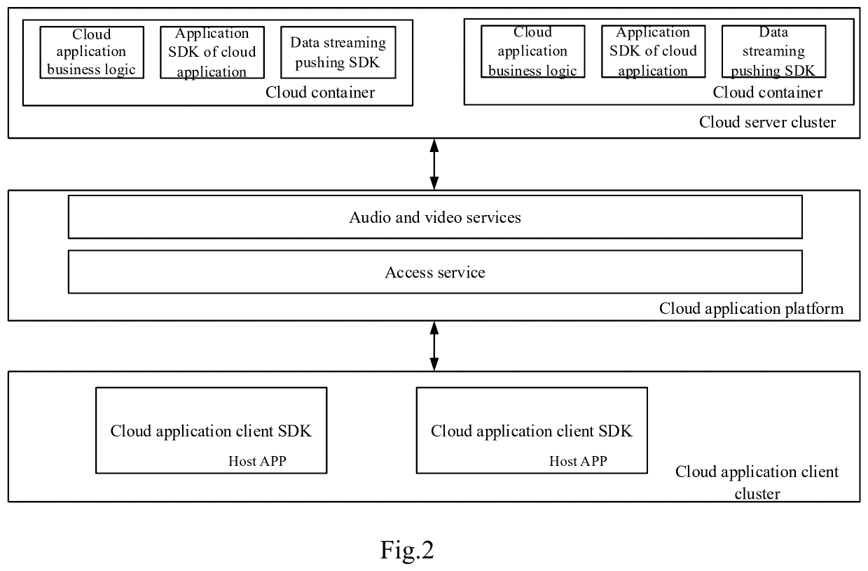

FIG. 2 is a structural diagram of a system according to an embodiment of the present disclosure. The system in the present disclosure includes a cloud application client cluster, a cloud application platform, and a cloud server cluster.

The cloud application may be considered as a software program running on a cloud server.

The cloud application client cluster is composed of multiple clients integrated on an electronic device, each client includes a host APP, and a cloud application client software development kit (SDK) can be integrated on the host APP. The cloud application client SDK is responsible for interacting with the cloud application platform to implement the functions such as control and display of the cloud application. The host APP can provide a running environment for the client SDK. The host APP may be an application for providing a running environment for a cloud application client.

The cloud application client SDK functions as follows.
1. A visible interface, where a user can operate an interface of the cloud application client;
2. A connection with the cloud application platform is established, and an operation instruction is transmitted to the cloud application platform.
3. The connection with the cloud application platform is established, data needing to be displayed by the cloud application platform is received, and a policy dispatched by the cloud application platform is executed.
4. The SDK is integrated on the host APP and interacts with the host APP.

The cloud application platform is mainly composed of an access service, and audio and video services. The cloud application platform provides the access service to facilitate each terminal device to access the cloud application platform, which is responsible for allocating a machine and launching the cloud application. The cloud application platform incorporates audio and video services, which is responsible for audio and video related service logic, such as handling and transmitting audio and video data of the cloud application.

The cloud server cluster is configured to provide computing and storage capacity for the overall system. The cloud server cluster includes multiple cloud containers. The cloud container plays a role of isolation and resource management. The cloud container carries a cloud application business logic and a related service, thereby ensuring that different cloud applications and services can run in independent environments, and rationally allocating resources of the cloud server cluster.

An application SDK of the cloud application is integrated in the application program and functions as follows.
1. The application SDK is integrated in the application program to interact with the application program.
2. The application SDK interacts with the cloud application platform to receive and execute a policy dispatched by the cloud application platform.

A data streaming push SDK functions as follows:
1. The data streaming push SDK serves for audio and video streaming push of the cloud application.
2. The data streaming push SDK interacts with the application SDK of the cloud application.

A cloud application container, which is also called a cloud container, functions as follows.
1. The cloud application container runs an application as a machine where the cloud application actually runs.
2. A connection with the cloud application platform is established, and data is transmitted to the cloud application platform.
3. An operation instruction transmitted by the cloud application platform is executed.

The purpose of the present disclosure is to solve the problem that the cloud application is affected by the cloud container when being run, such as limited performance (excessively high CPU (Central Processing unit) and memory load), or a vulnerability within the game itself makes it impossible to continue running the cloud application, and more seriously, there is a cloud application crash.

For example, taking the cloud application as cloud gaming, the cloud application may be considered as the cloud gaming, the cloud server cluster may be considered as a server cluster of the cloud gaming, and the cloud application platform may be considered as a cloud gaming platform. The cloud gaming can transfer running and processing process of the game from to a cloud server from a local device of the user. In the cloud, the server cluster is responsible for computing, rendering and other tasks of the game. The user sends an operation instruction to the cloud server by using various electronic devices (such as a smart phone, a tablet computer, a smart TV, and a computer), the cloud server, after receiving the instruction, is configured to perform corresponding processing and transmit a game screen back to the electronic device of the user in real time in the form of video streaming. The user can watch the game screen processed in the cloud on the electronic device, and send an operation instruction to the cloud through an input device (such as a keyboard, a mouse, a gamepad, and a touch screen) to implement interaction with the game.

The cloud server cluster is configured to provide computing power for the cloud gaming system. In the cloud gaming, the running, rendering and other complex computing tasks of the game are performed in the cloud. Multiple servers in the cloud server cluster can process tasks concurrently to ensure that the game can run with a high frame rate and high definition.

In conjunction with the foregoing system, a multimedia data processing method provided by the present disclosure is as shown in FIG. 1, where the method includes the following steps.

S110: transmitting a first launch request of a cloud application.

The first launch request is a request for triggering to launch the cloud application. Content included in the first launch request is not limited here, as long as the launching of the cloud application can be triggered. If the first launch request may include an identifier of a cloud application needing to be triggered to launch, the identifier can uniquely identify the cloud application. The first launch request may also include an identifier of an electronic device, where the identifier can uniquely identify the electronic device.

The present disclosure has no limitation on how the electronic device triggers the transmission of the first launch request. For example, the transmission of the first launch request can be triggered by clicking a control of the cloud application in a host APP. The first launch request may be transmitted to a cloud application platform to trigger the launching of the application.

S120. obtaining multimedia data of at least two application instances.

The multimedia data may be considered as a data set of different types of media content. The multimedia data includes an image, an audio, a video, a text and other media content. The media content may refer to information and materials presented through various media forms.

After the first launch request is transmitted, the cloud server can create an instance for the cloud application and transmit multimedia data of the instance to the electronic device to be displayed on an electronic device side.

In this embodiment, multimedia data of the at last two application instances are obtained in response to the first launch request, for example, the multimedia data of two application instances are obtained. This operation can obtain the instance of the application from the cloud server through the cloud application platform.

The at least two application instances are instances launched for the cloud application on different cloud containers, the different cloud containers correspond to different running environments of the cloud application, and the application instances at least include a first instance and a second instance, where the first instance may be a primary instance of the cloud application, and the second instance may be a standby instance of the cloud application. The primary instance is an instance of processing a task, the task includes a task associated with the cloud application, and the multimedia data of the second instance is not displayed. A display state may be considered as a state that characterizes whether the multimedia data of the second example is displayed or not. The running environment may refer to the sum of various conditions and resources that the cloud application depends on in the running process.

In this embodiment, the multimedia data of the second instance is not displayed, so that the multimedia data of the second instance is not displayed on an electronic device end.

For example, taking the cloud application as cloud gaming, the application instance may be understood as a running scenario of the cloud gaming. The application instance may be an independent computing unit created through virtualization on the basis of a physical server. Each application instance may have its own independent operating system, a computing resource (such as CPU, an internal memory) and configuration.

The cloud container plays a role of isolation and resource management in the cloud gaming. The application instance is isolated from other instances and other portions of the cloud server to ensure that various application instances does not interfere with each other. In addition, the cloud container is responsible for allocating required computing, storage and network resources for the application instance. The application instance includes a complete state of the game at a certain moment, which covers various elements in the game, such as a state of a character (including position, level and equipment) and a state of a game scenario (including terrain, buildings, and the like).

The multimedia data includes a screen, which may be presented content of the application instance on the electronic device. The content of a game world is displayed through images, animations and effects.

The application instance provides game contents, the cloud container provides resource guarantee for the application instance, the screen is a presentation of the application instance through the support of the cloud container, which together constitute the cloud gaming.

The cloud application run by the electronic device is provided by the primary instance (namely, the first instance). Data processing, screen rendering and other tasks of the cloud application can be performed on the primary instance. For example, when the user performs the operation, the operation instruction is sent to the primary instance, and the primary instance performs computing according to the operation instruction and returns a rendered game screen to the electronic device.

The standby instance is on standby and does not directly participate in the running of the game, but will load saved data of the primary instance, so that the standby instance can execute the task associated with the cloud application, such as data processing and screen rendering, for the cloud application when the primary instance is abnormal.

The instance data refers to data generated for saving a progress, a state, settings and other information of the cloud application in the cloud application. The instance data include progress information of the game, state data of a character, setting data of the game, and/or data of collected items, and the like.

In an embodiment, instance data in the second instance is loaded in real time, at regular intervals or when the first instance is abnormal, where the instance data is data stored by the first instance.

In this embodiment, the second instance loads the data stored by the first instance in real time; the second instance loads the data stored by the first instance at regular intervals; or the second instance loads the data stored by the first instance when the first instance is abnormal, thereby ensuring accuracy of the multimedia data provided by the second instance.

In this embodiment, when the first instance is abnormal, the second instance loads the instance data of the first instance, where the instance data may be a final state of the cloud application when the first instance is abnormal. The second instance can load only the final state, thereby avoiding the waste of a cloud container resource caused by loading an intermediate state.

If the cloud application is cloud gaming, when the cloud gaming is abnormal, the final game progress of the cloud gaming can be saved by loading saved data of the first instance.

This operation can obtain the multimedia data of the at least two application instances in real time.

S130. displaying the multimedia data of the first instance.

After obtaining the multimedia data of the application instance, this operation can display the multimedia data of the first instance, for example, multiple forms of multimedia data including images, audio, video and others can be displayed.

S140. switching displayed content from the multimedia data of the first instance to the multimedia data of the second instance when the first instance is abnormal.

The anomaly of the first instance can be considered that a situation not conforming to a normal running state occurs in the first instance. When the first instance is abnormal, the content displayed by the electronic device is switched from the multimedia data of the first instance to the multimedia data of the second instance.

Whether the first instance is abnormal or not can be detected on the electronic device side, or the server side. When the first instance is detected on the server side, this operation can obtain information indicating that the first instance is abnormal from the server side, thereby determining that the first instance is abnormal.

In an embodiment, the normal running process of the cloud application is as follows: the electronic device launches the cloud application, the cloud server launches two application instances which are a first instance and a second instance, the multimedia data of the first instance may be called as a main stream, and the multimedia data of the second instance may be called a disaster recovery stream. The electronic device displays the multimedia data of the first instance by default, and the multimedia data of the second instance is not displayed. The first instance synchronizes the instance data to the second instance in real time or at regular intervals, thereby synchronizing the progress of the cloud application.

In an embodiment, when the cloud application is abnormal, a disaster recovery flow is as follows: the first instance is abnormal, such as crash. When detecting that the first instance is abnormal, the electronic device is informed to launch the multimedia data of the second instance as the main stream, thereby achieving seamless switching. The electronic device informs the cloud server to launch a new standby instance.

According to the technical solution of the embodiment of the present disclosure, the first launch request of the cloud application is transmitted, the multimedia data of the at least two application instances in response to the first launch request are obtained, and the multimedia data of the first instance serving as the primary instance is displayed. When the primary instance is abnormal, the displayed multimedia data is switched to the multimedia data of the second instance serving as the standby instance, thereby avoiding a situation of relaunching the cloud application to recover to the normal when the cloud application is abnormal. The stability of the cloud application is improved.

On the basis of the foregoing embodiments, a variant embodiment of the foregoing embodiment is put forward, and it should be noted here that to make the description brief, only the differences from the foregoing embodiment are described in the variant embodiment.

In an embodiment, switching the displayed content from the multimedia data of the first instance to the multimedia data of the second instance when the first instance is abnormal includes the following.

obtaining indication information that the first instance is abnormal; and

switching the displayed content from the multimedia data of the first instance to the multimedia data of the second instance in response to the indication information.

The first instance is the primary instance of the cloud application, the second instance is the standby instance of the cloud application, the primary instance is an instance of processing a task, and the task includes a task associated with the cloud application.

The indication information may be considered as information that the server side indicates that the first instance of the electronic device is abnormal. In this embodiment, the server side determines whether the first instance is abnormal or not. After determining that the first instance is abnormal, the indication information is transmitted to inform the electronic device.

In this embodiment, the indication information is analyzed to determine that the first instance is abnormal. In response to the indication information, the displayed content is switched to the multimedia data of the second instance by the electronic device, so that the electronic device can display the cloud application as normal.

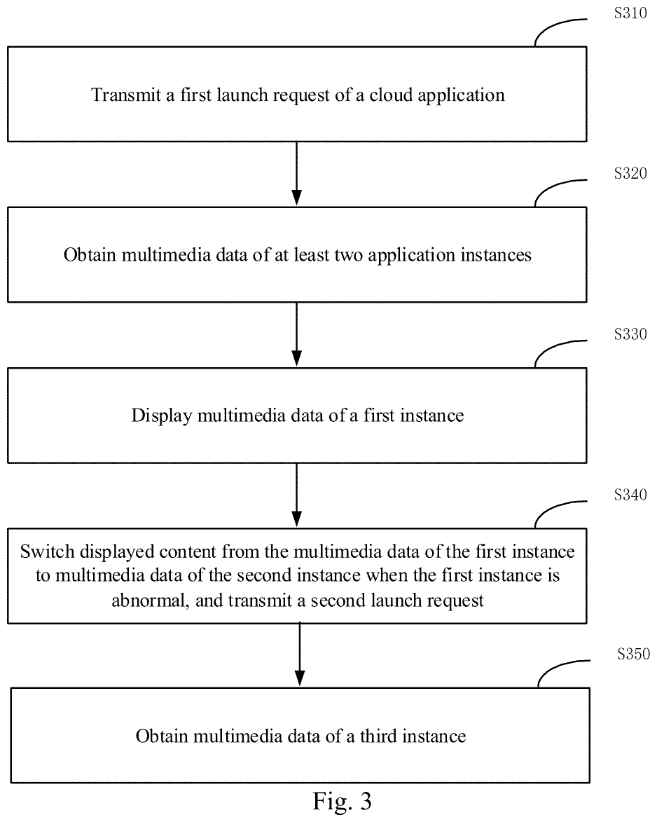

FIG. 3 is a flowchart of another multimedia data processing method according to an embodiment of the present disclosure. This embodiment further includes an operation of launching the standby instance. As shown in FIG. 3, this embodiment includes the following steps.
S310: transmitting a first launch request of a cloud application.
S320: obtaining multimedia data of at least two application instances.
S330: displaying multimedia data of a first instance.
S340: switching displayed content from the multimedia data of the first instance to multimedia data of the second instance when the first instance is abnormal, and a second launch request is transmitted.

The second launch request is a request for triggering to launch the standby instance of the cloud application.

In this embodiment, the displayed content is switched from the multimedia data of the first instance to the multimedia data of the second instance. Here, the second instance replaces the first instance as the primary instance of the cloud application. Based on this, the electronic device can send the second launch request to a server through a cloud application platform to request the server to launch a new standby instance for the cloud application, thereby switching to a new standby instance when the second instance is abnormal.

Content included in the second launch request is not limited here, which may include an identifier for indicating the cloud application, and an identifier for identifying the electronic device.

S350: displaying multimedia data of a third instance.

The server, after obtaining the second launch request, may create the third instance for the cloud application to serve as the standby instance of the cloud application. A cloud container where the third instance is located and a cloud container where the second instance is located are different cloud containers. The cloud container where the third instance is located and the cloud container where the second instance is located may be different cloud containers, thereby providing different running environments for the cloud application of the electronic device to avoid instance anomaly caused by hardware failure.

In this embodiment, when the first instance is abnormal and the displayed content is switched to the multimedia data of the second instance, the second launch request is transmitted to facilitate the cloud application to have the standby instance all the time, so that after the primary instance is abnormal, the primary instance can be switched to the standby instance to ensure the fluency of the cloud application.

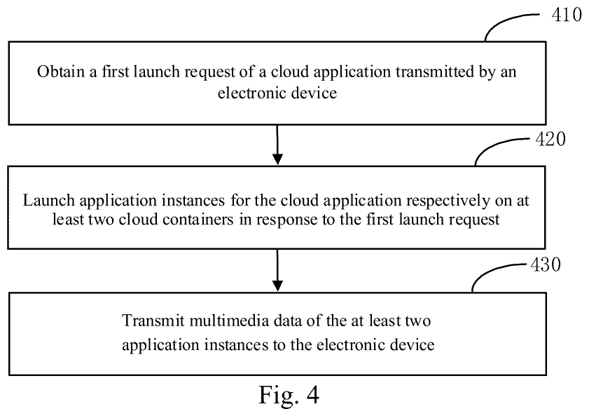

FIG. 4 is a flowchart of still another multimedia data processing method according to an embodiment of the present disclosure. The embodiment of the present disclosure is applicable to disaster recovery of a cloud application. The method can be executed by a multimedia data processing apparatus, which can be implemented in the form of software and/or hardware, or alternatively by a server, where the server may include multiple containers. As shown in FIG. 4, this embodiment includes the following steps.

S410: obtaining a first launch request of a cloud application transmitted by the electronic device.

The first launch request is a request for triggering to launch the cloud application.

This operation can obtain the first launch request transmitted by the electronic device through the cloud application platform.

S420: launching application instances for the cloud application respectively on at least two cloud containers in response to the first launch request.

The application instance at least includes a first instance and a second instance, the first instance is a primary instance of the cloud application, the second instance is a standby instance of the cloud application, the primary instance is an instance of processing a task, the task includes a task associated with the cloud application, and the multimedia data of the second instance is not displayed.

After obtaining the first launch request, this operation can analyze the first launch request. After determining that the electronic device triggers to launch the cloud application, the application instance of the cloud application is launched on at least two cloud containers of the server.

In this embodiment, for one cloud application, instances for at least one cloud application are launched on different cloud containers, thereby performing disaster recovery on the cloud application.

After the application instances are created, one of the application instances is configured to provide computing power for the cloud application in response to the cloud application, that is, serving as the primary instance. The other application instances serve as standby instances.

S430: Transmitting multimedia data of the at least two application instances to the electronic device.

This operation can transmit the multimedia data of the application instance created for the cloud application to the electronic device, so that the electronic device can display the multimedia data of the cloud application.

The multimedia processing method provided by this embodiment is executed by the server, the server obtains the first launch request transmitted by the electronic device and launches at least two application instances for the cloud application, thereby providing the primary instance and the standby instance for the cloud application. Afterwards, the multimedia data of the at least two application instances are transmitted to the electronic device for the electronic device to display the multimedia data of the application instance. When the primary instance is abnormal, the electronic device can implement anomaly disaster recovery of the cloud application by using the standby instance.

On the basis of the foregoing embodiment, a variant embodiment of the foregoing embodiment is put forward, and it should be noted here that to make the description brief, only the differences from the foregoing embodiment are described in the variant embodiment.

In an embodiment, the multimedia data processing method further includes the following.
storing data of the first instance in real time, at regular intervals or when the first instance is abnormal, to obtain instance data;
transmitting the instance data to the second instance;
loading the instance data in the second instance.

The first instance is a primary instance of the cloud application, the second instance is a standby instance of the cloud application, the primary instance is an instance of processing a task, and the task includes a task associated with the cloud application.

The server stores the data of the first instance in real time, at regular intervals or when the first instance is abnormal, to obtain the instance data.

The instance data is a copy of the data in the first instance and may include various types of information. For example, in one cloud application, the instance data may include settings of the cloud application, data in a database, and the like. In one game, the instance data may include information of a character. These data can be stored in different formats or technologies, such as database storage and file storage, depending on characteristics of application scenarios and data.

The instance data is transmitted to the second instance to implement backup of the data.

The second instance can load the instance data after obtaining the instance data. The process of loading the instance data includes reading the instance data, analyzing a data format, loading the data to a memory or storage of the second instance, and updating a state of the second instance according to the content of the data. For example, in one software application, loading the instance data may include reading a configuration file, recovering a layout of a user interface, loading data in the dataset, and other operations.

Loading the instance data in the second instance can improve reliability and usability.

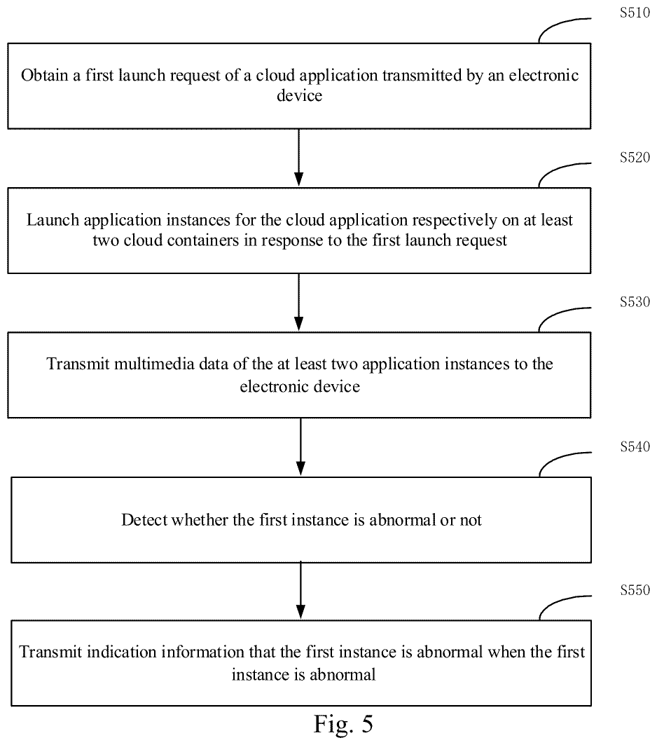

FIG. 5 is a flowchart of yet another multimedia data processing method according to an embodiment of the present disclosure. This embodiment further includes an operation for indicating that the first instance is abnormal. As shown in FIG. 5, this embodiment includes the following steps.
S510: obtaining a first launch request of a cloud application transmitted by the electronic device.
S520: launching application instances for the cloud application respectively on at least two cloud containers in response to the first launch request.
S530. transmitting multimedia data of the at least two application instances to the electronic device.
S540. detecting whether the first instance is abnormal or not.

After at least two application instances are launched, as the first instance serves as the primary instance of the cloud application, this operation can detect whether the first instance is abnormal or not. The detection means are not limited, whether the first instance is abnormal or not can be detected from software and hardware dimensions.

In one embodiment, detecting whether the first instance is abnormal or not includes the following.

Whether a running environment of the cloud application and the cloud application are abnormal or not are detected through a cloud container where the first instance is located.

In this embodiment, whether the running environment is abnormal or not can be checked by the cloud container itself. For example, whether the cloud container is abnormal or not is detected by a data streaming push SDK in FIG. 2. During abnormal detection of the cloud container, whether a hardware resource is abnormal or not can be detected, such as the detection of CPU usage, memory usage, storage capacity, and a network bandwidth.

In this embodiment, an interface can be provided for a cloud application business logic through an application SDK of the cloud application in the cloud container, and the cloud application business logic can transmit anomalies of the cloud application itself to the application SDK of the cloud application.

S550: transmitting indication information that the first instance is abnormal when the first instance is abnormal.

When the first instance is abnormal, this operation can transmit the indication information that the first instance is abnormal, thereby indicating the electronic device to switch the application instance.

In this embodiment, whether the first instance is abnormal or not is detected on a server side. When the first instance is abnormal, the electronic device is informed to switch the application instance, thereby solving the anomaly of the cloud application in time and implement rapid recovery of the cloud application.

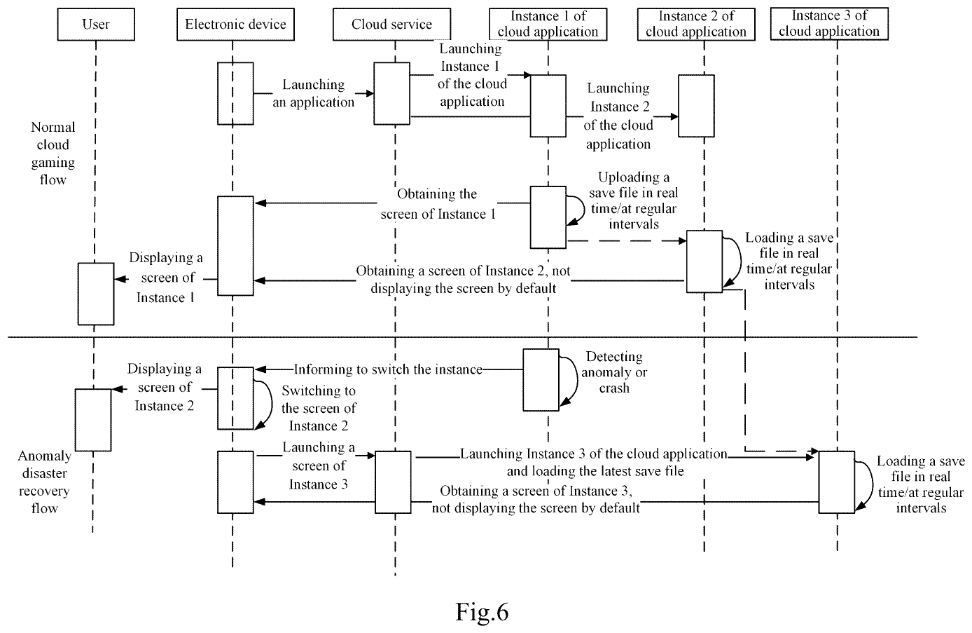

FIG. 6 is a diagram of system interaction according to an embodiment of the present disclosure. With reference to FIG. 6, the electronic device transmits the first launch request to trigger a cloud server (for providing a cloud service for the cloud application of the electronic device) to launch the application. The cloud service launches Instance 1 (namely, the first instance) of the cloud application and Instance 2 (namely, the second instance) of the cloud application. Instance 1 uploads the instance data in real time/at regular intervals, and Instance 2 loads the instance data in real time/at regular intervals.

The electronic device obtains a screen of Instance 1, namely, multimedia data of the first instance, and a screen of Instance 2, namely, the multimedia data of the second instance. The screen of Instance 2 is not displayed by default, that is, a state is not displayed. The electronic device displays the screen of Instance 1 to the user.

In the anomaly disaster recovery flow, Instance 1 of the cloud server detects whether there is anomaly or crash. When detecting the anomaly or crash, the electronic device is informed to switch the instance, that is, transmitting the indication information. The electronic device, after obtaining the indication information, can switch the displayed content to the screen of Instance 2, namely, the multimedia data of the second instance. The screen of Instance 2 is displayed to the user.

The electronic device can transmit a second launch request to trigger to launch a screen of Instance 3. The cloud service, after receiving the second launch request, launches Instance 3 of the cloud application and loads the latest instance data. Instance 3 can upload the instance data in real time/at regular intervals. The electronic device obtains the screen of Instance 3 (that is, obtaining the multimedia data of the third instance), and it is default that no screen is displayed.

When loading a save file, a final state of the cloud application can be loaded.

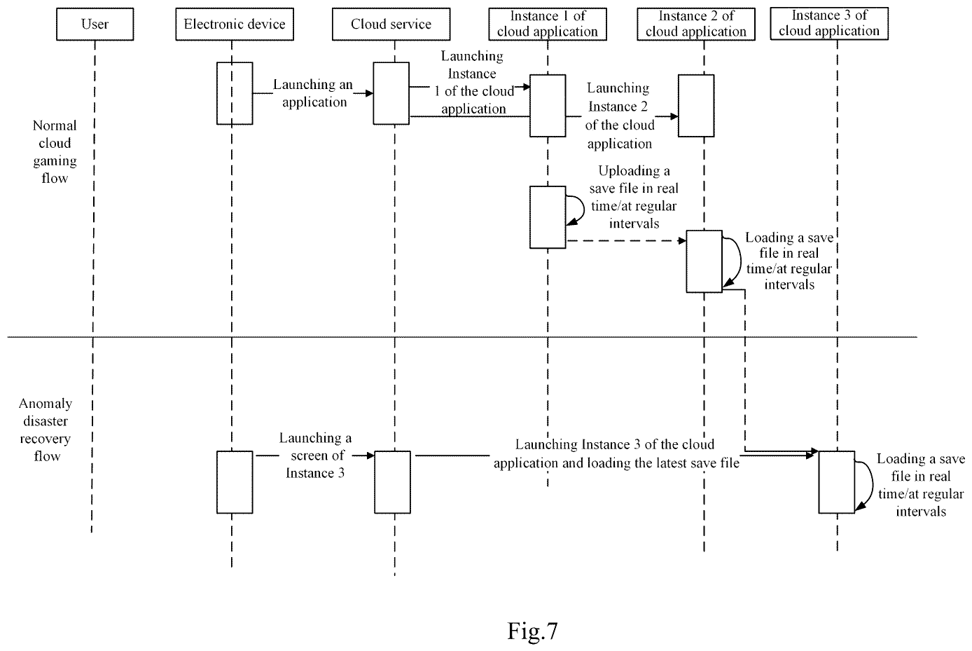

FIG. 7 is a flowchart of synchronization according to an embodiment of the present disclosure. With reference to FIG. 7, the electronic device triggers the cloud service to launch the application, namely, the cloud application. The cloud service launches Instance 1 of the cloud application and Instance 2 of the cloud application. After Instance 1 is launched, the instance data is uploaded in real time/at regular intervals. Instance 2 uploads the instance data in real time/at regular intervals. After the anomaly disaster recovery, Instance 2 servers as a primary instance, the electronic device triggers the cloud service to launch a screen of Instance 3, the cloud service launches Instance 3 of the cloud application and loads the latest instance data. Instance 3 loads the instance data in real time/at regular intervals.

Different cloud containers may have different configurations. Difference instances are launched in advance. When the primary instance is abnormal, it is directly switched to the standby instance, the process of launching the instance during the switching process is saved, and instance switching can be rapidly achieved.

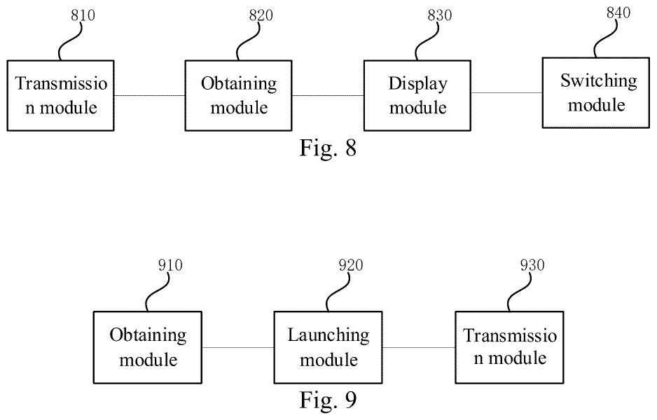

FIG. 8 is a structural diagram of a multimedia data processing apparatus according to an embodiment of the present disclosure. The multimedia data processing apparatus provided by this embodiment can be integrated into the electronic device, as shown in FIG. 8, the apparatus includes:
a transmission module 810, configured to transmit a first launch request of a cloud application, where the first launch request is a request for triggering to launch the cloud application;
an obtaining module 820, configured to obtain multimedia data of at least two application instances, where the at least two application instances are instances launched for the cloud application on different cloud containers, the different cloud containers correspond to different running environments of the cloud application, and the application instances at least include a first instance and a second instance;
a display module 830, configured to display multimedia data of the first instance; and
a switching module 840, configured to switch displayed content from the multimedia data of the first instance to multimedia data of the second instance when the first instance is abnormal.

According to the technical solution of the embodiment of the present disclosure, the transmission module is configured to transmit the first launch request of the cloud application, the obtaining module is configured to obtain multimedia data of at least two application instances in response to the first launch request, the display module is configured to display the multimedia data of the first instance serving as the primary instance is displayed, and the switching module is configured to switch the displayed multimedia data switched to the multimedia data of the second instance serving as a standby instance when the primary instance is abnormal, thereby avoiding a situation of relaunching the cloud application to recover to normal when the cloud application is abnormal. The stability of the cloud application is improved.

In an embodiment, the switching module 840 is specifically configured to:
obtain indication information that the first instance is abnormal; and
switch the displayed content from the multimedia data of the first instance to the multimedia data of the second instance in response to the indication information.

The first instance is the primary instance of the cloud application, the second instance is the standby instance of the cloud application, the primary instance is an instance of processing a task, and the task includes a task associated with the cloud application.

In an embodiment, a multimedia data processing apparatus further includes an anomaly processing module, configured to:
transmit a second launch request when the first instance is abnormal, where the second launch request is a request for triggering to launch the standby instance of the cloud application; and
obtain multimedia data of a third instance, where a cloud container where the third instance is located and a cloud container where the second instance is located are different cloud containers.

In an embodiment, instance data in the second instance is loaded in real time, at regular intervals or when the first instance is abnormal, where the instance data is data stored by the first instance.

The multimedia data processing apparatus provided by the embodiment of the present disclosure can execute the multimedia data processing method provided by the embodiment of the present disclosure, and has corresponding functional modules and beneficial effects for executing the method.

It is worth noting that various units and modules included in the foregoing apparatus are only divided according to functional logics, but are not limited to the foregoing division, as long as the corresponding functions can be implemented. In addition, specific names of the functional units are only for the convenience of distinguishing each other, and are not used to limit the scope of protection of the embodiment of the present disclosure.

FIG. 9 is a structural diagram of another multimedia data processing apparatus according to an embodiment of the present disclosure. The multimedia data processing apparatus provided by this embodiment can be integrated into a server. As shown in FIG. 9, the apparatus includes:
an obtaining module 910, configured to obtain a first launch request of a cloud application transmitted by an electronic device, where the first launch request is a request for triggering to launch the cloud application;
a launching module 920, configured to launch application instances for the cloud application on at least two cloud containers in response to the first launch request, where the application instances at least include a first instance and a second instance; and
a transmission module 930, configured to transmit multimedia data of the at least two application instances to the electronic device.

The technical solution provided by the embodiment of the present disclosure is executed by the server, the server obtains the first launch request transmitted by the electronic device, and launches at least two application instances for the cloud application, thereby providing a primary instance and a standby instance for the cloud application. Multimedia data of the at least two application instances are transmitted to the electronic device for the electronic device to display the multimedia data of the application instance. When the primary instance is abnormal, the electronic device can implement anomaly disaster recovery of the cloud application by using the standby instance.

In an embodiment, a multimedia data processing apparatus further includes a storage module, configured to:
store data of the first instance in real time, at regular intervals or when the first instance is abnormal, to obtain instance data;
transmit the instance data to the second instance; and
load the instance data in the second instance.

The first instance is a primary instance of the cloud application, the second instance is a standby instance of the cloud application, the primary instance is an instance of processing a task, and the task includes a task associated with the cloud application.

In an embodiment, the multimedia data processing apparatus further includes a detection module, which includes:
a detection unit, configured to detect whether the first instance is abnormal or not; and
a transmission unit, configured to transmit indication information that the first instance is abnormal when the first instance is abnormal.

In an embodiment, the detection unit is specifically configured to:
detect whether a running environment of the cloud application and the cloud application are abnormal or not through a cloud container where the first instance is located.

The multimedia data processing apparatus provided by the embodiment of the present disclosure can execute the multimedia data processing method provided by the embodiment of the present disclosure, and has corresponding functional modules and beneficial effects for executing the method.

It is worth noting that various units and modules included in the foregoing apparatus are only divided according to functional logics, but are not limited to the foregoing division, as long as the corresponding functions can be implemented. In addition, specific names of the functional units are only for the convenience of distinguishing each other, and are not used to limit the scope of protection of the embodiment of the present disclosure.

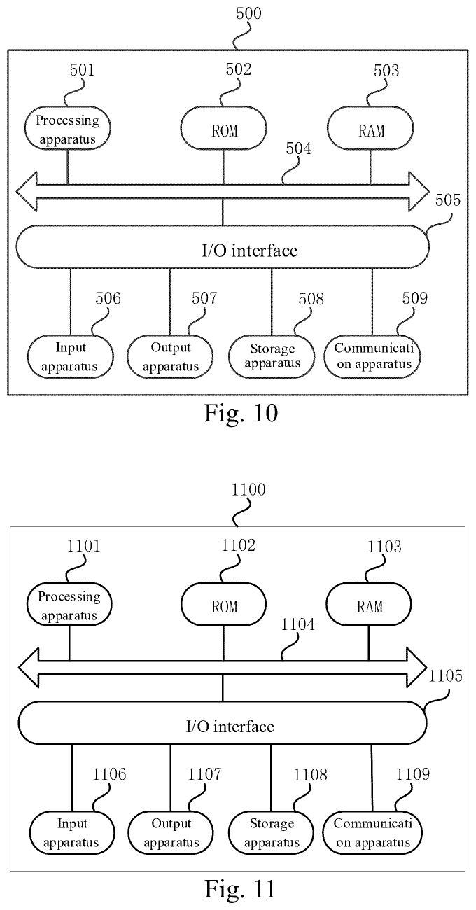

FIG. 10 is a structural diagram of an electronic device according to an embodiment of the present disclosure. With reference to FIG. 10, the following shows a structural diagram of an electronic device (for example, a terminal device or server in FIG. 10) 500 suitable for implementing the embodiment of the present disclosure.

The electronic device 500 includes:
one or more processing apparatuses 501; and
a storage apparatus 508, configured to store one or more programs.

When the one or more programs are executed by the one or more processing apparatuses 501, the one or more processing apparatuses 501 are enabled to implement any method according to the present disclosure.

The terminal device in the embodiment of the present disclosure may include, but is not limited to, a mobile terminal such as a mobile phone, a notebook computer, a digital broadcast receiver, PDA (Personal Digital Assistant), PAD (Tablet Computer), PMP (Portable Multimedia Player), a vehicle-mounted terminal (such as a vehicle-mounted navigation terminal), as well as a fixed terminal such as a digital TV and a desktop computer. The electronic device shown in FIG. 10 is only an example, which should not bring any limitation to the function and usage range of the embodiment of the present disclosure.

As shown in FIG. 10, the electronic device 500 may include the processing apparatus (such as a central processing unit, and a graphics processing unit) 501, which may execute various proper actions or processing according to a program stored in a read-only memory (ROM) 502 or a program loaded into a random-access memory (RAM) 503 from the storage apparatus 508. Various programs and data required for the operation of the electronic device 500 are also stored in RAM 503. The processing apparatus 501, ROM 502 and RAM 503 are connected to one another by a bus 504. An input/output (I/O) interface 505 is also connected to the bus 504.

In general, the following apparatuses may be connected to the I/O interface 505, including an input apparatus 506 such as a touch screen, a touch tablet, a mouse, a camera, a microphone, an accelerometer and a gyroscope; an output apparatus 507 such as a liquid crystal display (LCD), a speaker and a vibrator; and a storage apparatus 508 such as a magnetic tape and a hard disk, and a communication apparatus 509. The communication apparatus 509 may allow the electronic device 500 to communicate with other devices in a wireless or wired manner for data exchange. Although FIG. 10 shows the electronic device 500 with various apparatuses, it should be understood that it is not required to implement or have all the illustrated apparatuses, and more or fewer apparatuses may be alternatively implemented or provided.

In particular, the process described above with reference to the flowchart may be implemented as a computer software program according to an embodiment of the present disclosure. For example, an embodiment of the present disclosure includes a computer program product, which includes a computer program carried on a non-transient computer-readable medium, which includes a program code for executing the method shown in the flowchart. In this embodiment, the computer program can be loaded and installed from the network via the communication apparatus 509, or installed from the storage apparatus 508, or installed from ROM 502. When the computer program is executed by the processing apparatus 501, the foregoing functions defined in the method of the embodiment of the present disclosure are performed.

Names of messages or information exchanged among multiple apparatuses in the embodiments of the present disclosure are only used for illustrative purposes, and are not used to limit the scope of these messages or information.

The electronic device provided by the embodiment of the present disclosure belongs to the same inventive concept as the multimedia data processing method provided by the foregoing embodiments, and the technical details not described in detail in this embodiment can be found in the foregoing embodiments, and this embodiment has the same beneficial effects as the foregoing embodiments.

FIG. 11 is a structural diagram of a server according to an embodiment of the present disclosure. With reference to FIG. 11, the following shows a structural diagram of a server 1100 suitable for implementing the embodiment of the present disclosure.

The server 1100 includes:
one or more processing apparatuses 1101; and
a storage apparatus 1108, configured to store one or more programs.

When the one or more programs are executed by the one or more processing apparatuses 1101, the one or more processing apparatuses 1101 are enabled to implement any method according to the present disclosure.

The terminal device in the embodiment of the present disclosure may include, but is not limited to, a mobile terminal such as a mobile phone, a notebook computer, a digital broadcast receiver, PDA (Personal Digital Assistant), PAD (Tablet Computer), PMP (Portable Multimedia Player), a vehicle-mounted terminal (such as a vehicle-mounted navigation terminal), as well as a fixed terminal such as a digital TV and a desktop computer. The server shown in FIG. 11 is only an example, which should not bring any limitation to the function and usage range of the embodiment of the present disclosure.

As shown in FIG. 11, the server 1100 may include the processing apparatus (such as a central processing unit, and a graphics processing unit) 1101, which may execute various proper actions or processing according to a program stored in a read-only memory (ROM) 1102 or a program loaded into a random-access memory (RAM) 1103 from the storage apparatus 1108. Various programs and data required for the operation of the server 1100 are also stored in RAM 1103. The processing apparatus 1101, ROM 1102 and RAM 1103 are connected to one another by a bus 1104. An input/output (I/O) interface 1105 is also connected to the bus 1104.

In general, the following apparatuses may be connected to the I/O interface 1105, including an input apparatus 1106 such as a touch screen, a touch tablet, a mouse, a camera, a microphone, an accelerometer and a gyroscope; an output apparatus 1107 such as a liquid crystal display (LCD), a speaker and a vibrator; and a storage apparatus 1108 such as a magnetic tape and a hard disk, and a communication apparatus 1109. The communication apparatus 1109 may allow the server 1100 to communicate with other devices in a wireless or wired manner for data exchange. Although FIG. 11 shows the server 1100 with various apparatuses, it should be understood that it is not required to implement or have all the illustrated apparatuses, and more or fewer apparatuses may be alternatively implemented or provided.

In particular, the process described above with reference to the flowchart may be implemented as a computer software program according to an embodiment of the present disclosure. For example, an embodiment of the present disclosure includes a computer program product, which includes a computer program carried on a non-transient computer-readable medium, which includes a program code for executing the method shown in the flowchart. In this embodiment, the computer program can be loaded and installed from the network via the communication apparatus 1109, or installed from the storage apparatus 1108, or installed from ROM 1102. When the computer program is executed by the processing apparatus 1101, the foregoing functions defined in the method of the embodiment of the present disclosure are performed.

Names of messages or information exchanged among multiple apparatuses in the embodiments of the present disclosure are only used for illustrative purposes, and are not used to limit the scope of these messages or information.

The server provided by the embodiment of the present disclosure belongs to the same inventive concept as the multimedia data processing method provided by the foregoing embodiments, and the technical details not described in detail in this embodiment can be found in the foregoing embodiments, and this embodiment has the same beneficial effects as the foregoing embodiments.

An embodiment of the present disclosure further provides a computer program product on which a computer program is stored. The program, when executed by a processor, is configured to implement the multimedia processing method provided by the foregoing embodiment.

It should be noted that the computer-readable medium described above in the present disclosure may be a computer-readable signal medium, a computer-readable storage medium or any combination of the two.

The computer storage medium may be a storage medium of a computer-executable instruction, which, when executed by a computer processor, is configured to perform the method as provided in the present disclosure.

The computer readable storage medium, for example, may be, but is not limited to, electrical, magnetic, optical, electromagnetic, infrared, or semiconductor systems, apparatuses, or devices, or any combination of the above. More specific examples of the computer-readable storage media may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium containing or storing a program. The program can be used by or in combination with an instruction execution system, apparatus or device. In the present disclosure, the computer-readable signal medium may include a data signal propagated in a baseband or as part of a carrier wave, in which a computer-readable program code is carried. This propagated data signal may be in many forms, including, but not limited to, an electromagnetic signal, an optical signal, or any suitable combination of the above. The computer-readable signal medium may also be any computer-readable medium other than a computer-readable storage medium, which can send, propagate or transmit a program for use by or in connection with the instruction execution system, apparatus or device. The program code contained in the computer-readable medium can be transmitted by any suitable medium, including, but not limited to, a wire, an optical cable, RF (radio frequency) and the like, or any suitable combination of the above.

In some implementations, a client and a server can communicate by using any currently known or future developed network protocol such as HTTP (HyperText Transfer Protocol), and can be interconnected with digital data communication in any form or medium (for example, a communication network). An example of the communication network includes a local area network (“LAN”), a wide area network (“WAN”), an internet work (for example, internet) and an end-to-end network (for example, ad hoc end-to-end network), and any currently known or future developed network.

The foregoing computer-readable medium may be included in the foregoing electronic device, or exist alone without being assembled into the electronic device.

The foregoing computer-readable medium carries one or multiple programs, when one or multiple programs are executed by the electronic device, the electronic device is enabled to:
transmit a first launch request of a cloud application, where the first launch request is a request for triggering to launch the cloud application;
obtain multimedia data of at least two application instances, where the at least two application instances are launched for the cloud application on different cloud containers, the different cloud containers correspond to different running environments of the cloud application, and the application instances at least include a first instance and a second instance;
display multimedia data of the first instance; and
switch displayed content from the multimedia data of the first instance to multimedia data of the second instance when the first instance is abnormal.

Alternatively, the computer-readable medium carries one or multiple programs, when one or multiple programs are executed by the electronic device, the electronic device is enabled to: obtain a first launch request of a cloud application transmitted by the electronic device, where the first launch request is a request for triggering to launch the cloud application; and
launch application instances for the cloud application on at least two cloud containers in response to the first launch request, where the application instances at least include a first instance and a second instance; and
transmit the multimedia data of the at least two application instances to the electronic device.

Computer program codes for performing the operation of the present disclosure may be compiled in one or more programming languages or their combinations, the programming languages include, but are not limited to, object-oriented programming languages such as Java, Smalltalk, C++, and conventional procedural programming languages such as “C” or similar programming languages. The program codes can be completely executed on a user computer, partially executed on the user computer, executed as an independent software package, partially executed on the user computer and partially executed on a remote computer, or completely executed on a remote computer or server. When involving the remote computer, the remote computer can be connected to the user computer through any type of network, including a local area network (LAN) or a wide area network (WAN), or can be connected to an external computer (for example, connecting through Internet provided by an Internet service provider).

Flowcharts and block diagrams in the accompanying drawings illustrate architecture, functions and operations of possible implementations of systems, methods and computer program products according to various embodiments of the present disclosure. In this regard, each block in the flowchart or block diagram may represent a module, a program segment or a part of code that contains one or more executable instructions for implementing specified logical functions. It should also be noted that in some alternative implementations, the functions noted in the blocks may occur in a different order than those noted in the accompanying drawings. For example, two blocks shown in succession may actually be executed substantially in parallel, or may sometimes be executed in a reverse order, depending on the functions involved. It should also be noted that each block in the block diagram and/or flowchart, and combinations of blocks in the block diagram and/or flowchart, may be implemented by a dedicated hardware-based system that performs a specified function or operation, or by a combination of dedicated hardware and a computer instruction.

The module or unit described in the embodiments of the present disclosure can be implemented by software or hardware. A name of the module or unit does not constitute the limitation of the unit itself under certain circumstances. For example, the transmission module may also be described as the “first launch request transmission module”.

The functions described above herein may be at least partially performed by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD) and so on.

In the context of the present disclosure, a machine-readable medium may be a tangible medium that may include or store a program for use by or in combination with an instruction execution system, apparatus or device. The machine-readable medium may be a machine-readable signal medium, or a machine-readable storage medium. The machine-readable medium, for example, may include, but not limited to, electrical, magnetic, optical, electromagnetic, infrared, or semiconductor systems, apparatuses, or devices, or any suitable combination of the above contents. A more specific example of the machine-readable storage media may include an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above contents.

A computer program product includes a computer program, where the computer program, when executed by a processor, is configured to implement any multimedia processing method provided by the embodiment of the present disclosure. The computer program product has corresponding functional modules and beneficial effects for implementing the method.

According to one or more embodiments of the present disclosure, example one provides a multimedia processing method, including the following steps.

A first launch request of a cloud application is transmitted, where the first launch request is a request for triggering to launch the cloud application.

Multimedia data of at least two application instances are obtained, where the at least two application instances are launched for the cloud application on different cloud containers, the different cloud containers correspond to different running environments of the cloud application, and the application instances at least include a first instance and a second instance.

Multimedia data of the first instance is displayed.

Displayed content is switched from the multimedia data of the first instance to multimedia data of the second instance when the first instance is abnormal.

According to one or more embodiments of the present disclosure, example two provides the method described in example one, the displayed content is switched from the multimedia data of the first instance to the multimedia data of the second instance when the first instance is abnormal, including the following steps.

Indication information that the first instance is abnormal is obtained.

The displayed content is switched from the multimedia data of the first instance to the multimedia data of the second instance in response to the indication information.

The first instance is a primary instance of the cloud application, the second instance is a standby instance of the cloud application, the primary instance is an instance of processing a task, and the task includes a task associated with the cloud application.

According to one or more embodiments of the present disclosure, example three provides the method of example one, further including the following steps.

A second launch request is transmitted when the first instance is abnormal, where the second launch request is a request for triggering to launch the standby instance of the cloud application.

Multimedia data of a third instance is obtained, where a cloud container where the third instance is located and a cloud container where the second instance is located are different cloud containers.

According to one or more embodiments of the present disclosure, example four provides the method of the example one, instance data in the second instance is loaded in real time, at regular intervals or when the first instance is abnormal, where the instance data is data stored by the first instance.

According to one or more embodiments of the present disclosure, example five provides a multimedia processing method, including the following steps.

A first launch request of a cloud application transmitted by an electronic device is obtained, where the first launch request is a request for triggering to launch the cloud application.

Application instances for the cloud application are launched on at least two cloud containers in response to the first launch request, where the application instances at least include a first instance and a second instance.

Multimedia data of the at least two application instances are transmitted to the electronic device.

According to one or more embodiments of the present disclosure, example six provides the method of example five, further including the following steps.

Data of the first instance is stored in real time, at regular intervals or when the first instance is abnormal, to obtain instance data.

The instance data is transmitted to the second instance.

The instance data is loaded in the second instance, where the first instance is a primary instance of the cloud application, the second instance is a standby instance of the cloud application, the primary instance is an instance of processing a task, and the task includes a task associated with the cloud application.

According to one or more embodiments of the present disclosure, example seven provides the method of example five, further including the following steps.

Whether the first instance is abnormal or not is detected.

Indication information that the first instance is abnormal is transmitted when the first instance is abnormal.

According to one or more embodiments of the present disclosure, example eight provides the method of example seven, detecting whether the first instance is abnormal or not includes the following steps.

Whether a running environment of the cloud application and the cloud application are abnormal or not are detected through a cloud container where the first instance is located.

According to one or more embodiments of the present disclosure, example nine provides a multimedia processing apparatus, including:
a transmission module, configured to transmit a first launch request of a cloud application, where the first launch request is a request for triggering to launch the cloud application;
an obtaining module, configured to obtain multimedia data of at least two application instances, where the at least two application instances are instances launched for the cloud application on different cloud containers, the different cloud containers correspond to different running environments of the cloud application, the application instances at least include a first instance and a second instance, the first instance is a primary instance of the cloud application, the second instance is a standby instance of the cloud application, the primary instance is an instance of processing a task, the task includes a task associated with the cloud application, and multimedia data of the second instance is not displayed;
a display module, configured to display multimedia data of the first instance; and
a switching module, configured to switch displayed content from the multimedia data of the first instance to the multimedia data of the second instance when the first instance is abnormal.

According to one or more embodiments of the present disclosure, example ten provides a multimedia processing apparatus, including
an obtaining module, configured to obtain a first launch request of a cloud application transmitted by an electronic device, where the first launch request is a request for triggering to launch the cloud application;
a launching module, configured to launch application instances for the cloud application on at least two cloud containers in response to the first launch request, where the application instances at least include a first instance and a second instance, the first instance is a primary instance of the cloud application, the second instance is a standby instance of the cloud application, the primary instance is an instance of processing a task, the task includes a task associated with the cloud application, and multimedia data of the second instance is not displayed; and
a transmission module, configured to transmit multimedia data of the at least two application instances to the electronic device.

According to one or more embodiments of the present disclosure, example eleven provides an electronic device, including:
one or more processing apparatuses; and
a storage apparatus, configured to store one or more programs.

When the one or more programs are executed by the one or more processing apparatuses, the one or more processing apparatuses are enabled implement the multimedia processing method according to any one of Instances 1 to 4.

According to one or more embodiments of the present disclosure, example twelve provides a server, including:
one or more processing apparatuses; and
a storage apparatus, configured to store one or more programs.

When the one or more programs are executed by the one or more processing apparatuses, the one or more processing apparatuses are enabled implement the multimedia processing method according to any one of example five to eight.

According to one or more embodiments of the present disclosure, example thirteen provides a storage medium including a computer-executable instruction, where the computer-executable instruction, when executed by a computer processor, is configured to execute the multimedia processing method in any of example one to eight.

According to one or more embodiments of the present disclosure, example fourteen provides a computer program product, including a computer program, where the computer program, when executed by a processor, is configured to implement the multimedia processing method in any of example one to eight.

The foregoing description is only a preferred embodiment of the present disclosure and the explanation of the applied technical principles. It should be understood by those skilled in the art that the disclosure scope involved in the present disclosure is not limited to the technical solution formed by a specific combination of the above technical features, but also covers other technical solutions formed by any combination of the above technical features or their equivalent features without departing from the foregoing disclosure concept, for example, the technical solution formed by replacing the foregoing features with (but not limited to) technical features with similar functions disclosed in the present disclosure.

Furthermore, although the operations are depicted in a particular order, this should not be construed as requiring these operations to be performed in a particular order shown or in a sequential order. Under certain circumstances, multitasking and concurrent processing may be beneficial. Likewise, although several specific implementation details are contained in the above discussion, these should not be construed as limiting the scope of the present disclosure. Some features described in the context of a separate embodiment may also be combined in a single embodiment. On the contrary, various features described in the context of a single embodiment may also be implemented in multiple embodiments separately or in any suitable sub-combination.

Although the subject matter has been described in language specific to structural features and/or methodological logical acts, it should be understood that the subject matter defined in the appended claims is not necessarily limited to the specific features or actions described above. On the contrary, the specific features and actions described above are only exemplary forms of implementing the claims.

1. A multimedia data processing method, comprising:
transmitting a first launch request of a cloud application, wherein the first launch request is a request for triggering to launch the cloud application;
obtaining multimedia data of at least two application instances, wherein the at least two application instances are instances launched for the cloud application respectively on different cloud containers, the different cloud containers correspond to different running environments of the cloud application, and the application instances at least comprise a first instance and a second instance;
displaying multimedia data of the first instance; and
switching displayed content from the multimedia data of the first instance to multimedia data of the second instance when the first instance is abnormal.

2. The multimedia data processing method according to claim 1, wherein the switching displayed content from the multimedia data of the first instance to multimedia data of the second instance when the first instance is abnormal comprises:
obtaining indication information that the first instance is abnormal; and
switching the displayed content from the multimedia data of the first instance to multimedia data of the second instance in response to the indication information, wherein
the first instance is a primary instance of the cloud application, the second instance is a standby instance of the cloud application, the primary instance is an instance of processing a task, and the task comprises a task associated with the cloud application.

3. The multimedia data processing method according to claim 1, further comprising:
transmitting a second launch request when the first instance is abnormal, wherein the second launch request is a request for triggering to launch the standby instance of the cloud application; and
obtaining multimedia data of a third instance, wherein a cloud container where the third instance is located and a cloud container where the second instance is located are different cloud containers.

4. The multimedia data processing method according to claim 1, wherein instance data in the second instance is loaded in real time, at regular intervals or when the first instance is abnormal, and the instance data is data stored by the first instance.

5. A multimedia data processing method, comprising:
obtaining a first launch request of a cloud application transmitted by an electronic device, wherein the first launch request is a request for triggering to launch the cloud application;
launching application instances for the cloud application respectively on at least two cloud containers in response to the first launch request, wherein the application instances at least comprise a first instance and a second instance; and
transmitting multimedia data of the at least two application instances to the electronic device.

6. The multimedia data processing method according to claim 5, further comprising:
storing data of the first instance in real time, at regular intervals or when the first instance is abnormal, to obtain instance data;
transmitting the instance data to the second instance; and
loading the instance data in the second instance, wherein
the first instance is a primary instance of the cloud application, the second instance is a standby instance of the cloud application, the primary instance is an instance of processing a task, and the task comprises a task associated with the cloud application.

7. The multimedia data processing method according to claim 5, further comprising:
detecting whether the first instance is abnormal or not; and
transmitting indication information that the first instance is abnormal when the first instance is abnormal.

8. The multimedia data processing method according to claim 7, wherein the detecting whether the first instance is abnormal or not comprises:
detecting whether a running environment of the cloud application and the cloud application are abnormal or not through a cloud container where the first instance is located.

9. An electronic device, comprising:
at least one processing apparatus, and
a storage apparatus, configured to store at least one program, wherein
the at least one program, when executed by the at least one processing apparatus, causes the at least one processing apparatus to implement a multimedia processing method, the multimedia processing method comprises:
transmitting a first launch request of a cloud application, wherein the first launch request is a request for triggering to launch the cloud application;
obtaining multimedia data of at least two application instances, wherein the at least two application instances are instances launched for the cloud application respectively on different cloud containers, the different cloud containers correspond to different running environments of the cloud application, and the application instances at least comprise a first instance and a second instance;
displaying multimedia data of the first instance; and
switching displayed content from the multimedia data of the first instance to multimedia data of the second instance when the first instance is abnormal.

10. The electronic device according to claim 9, wherein the switching displayed content from the multimedia data of the first instance to multimedia data of the second instance when the first instance is abnormal comprises:
obtaining indication information that the first instance is abnormal; and
switching the displayed content from the multimedia data of the first instance to multimedia data of the second instance in response to the indication information, wherein
the first instance is a primary instance of the cloud application, the second instance is a standby instance of the cloud application, the primary instance is an instance of processing a task, and the task comprises a task associated with the cloud application.

11. The electronic device according to claim 9, wherein the processing apparatus is further configured to:
transmit a second launch request when the first instance is abnormal, wherein the second launch request is a request for triggering to launch the standby instance of the cloud application; and
obtain multimedia data of a third instance, wherein a cloud container where the third instance is located and a cloud container where the second instance is located are different cloud containers.

12. The electronic device according to claim 9, wherein instance data in the second instance is loaded in real time, at regular intervals or when the first instance is abnormal, and the instance data is data stored by the first instance.

13. A server, comprising:
at least one processing apparatus; and
a storage apparatus, configured to store at least one program, wherein
the at least one program, when executed by the at least one processing apparatus, causes the at least one processing apparatuses to implement the multimedia processing method according to claim 5.

14. The server according to claim 13, wherein the processing apparatus is further configured to:
store data of the first instance in real time, at regular intervals or when the first instance is abnormal, to obtain instance data;
transmit the instance data to the second instance; and
load the instance data in the second instance, wherein
the first instance is a primary instance of the cloud application, the second instance is a standby instance of the cloud application, the primary instance is an instance of processing a task, and the task comprises a task associated with the cloud application.

15. The server according to claim 13, wherein the processing apparatus is further configured to:
detect whether the first instance is abnormal or not; and
transmit indication information that the first instance is abnormal when the first instance is abnormal.

16. The server according to claim 15, wherein the detecting whether the first instance is abnormal or not comprises:
detecting whether a running environment of the cloud application and the cloud application are abnormal or not through a cloud container where the first instance is located.

17. A non-transitory storage medium containing a computer-executable instruction, wherein computer-executable instructions are stored on the non-transitory storage medium, the computer-executable instruction, when executed by a computer processor, causes the computer processor to implement the multimedia processing method according to claim 1.

18. The non-transitory storage medium according to claim 17, wherein the switching displayed content from the multimedia data of the first instance to multimedia data of the second instance when the first instance is abnormal comprises:
obtaining indication information that the first instance is abnormal; and
switching the displayed content from the multimedia data of the first instance to multimedia data of the second instance in response to the indication information, wherein
the first instance is a primary instance of the cloud application, the second instance is a standby instance of the cloud application, the primary instance is an instance of processing a task, and the task comprises a task associated with the cloud application.

19. The non-transitory storage medium according to claim 17, wherein the computer processor is further configured to:
transmit a second launch request when the first instance is abnormal, wherein the second launch request is a request for triggering to launch the standby instance of the cloud application; and
obtain multimedia data of a third instance, wherein a cloud container where the third instance is located and a cloud container where the second instance is located are different cloud containers.

20. The non-transitory storage medium according to claim 17, wherein instance data in the second instance is loaded in real time, at regular intervals or when the first instance is abnormal, and the instance data is data stored by the first instance.
